(19) United States
(12) Patent Application Publication
(10) Pub. No.: US 2026/0365783 A1
(43) Pub. Date: Nov. 19, 2026

(54) NANOSHEET-LIKE PARTICLES OF POLYTHIOPHENE-BASED COMPOUND AND METHOD FOR PRODUCING SAME

(71) Applicant: Japan Science and Technology Agency, Kawaguchi-shi, Saitama (JP)

(72) Inventors: Yoshiaki UCHIDA, Kyoto-shi (JP); Koki SASAKI, Takatsuki-shi (JP); Yuki TOKUDA, Otake-shi (JP)

(73) Assignee: Japan Science and Technology Agency, Kawaguchi-shi, Saitama (JP)

(21) Appl. No.: 19/118,174

(22) PCT Filed: Aug. 15, 2023
(86) PCT No.: PCT/JP2023/029497

§ 371 Date: Apr. 3, 2025

(30) Foreign Application Priority Data
Oct. 14, 2022 (JP) 2022-165782

(51) Int. Cl. C08G 61/12; B82Y 30/00; B82Y 40/00

(52) U.S. Cl. CPC C08G 61/126; B82Y 30/00; B82Y 40/00; C08G 2261/11; C08G 2261/3247; C08G 2261/43

(57) ABSTRACT

Nanosheet-like particles of a polythiophene-based compound having a thickness of 10 nm or less, which cannot be obtained by conventional methods, and a method for producing the same are described. In particular, a dispersion composition containing the nanosheet-like particles of a polythiophene-based compound are stable without aggregation. The nanosheet-like particles of a polythiophene-based compound have a thickness of 0.5 nm or more and 10 nm or less, and an aspect ratio (maximum width in the particle/thickness) of 100 or more.

### TECHNICAL FIELD

The present invention relates to nanosheet-like particles of a polythiophene-based compound and a method for producing the same.

Priority is claimed on Japanese Patent Application No. 2022-165782, filed on Oct. 14, 2022, the content of which is incorporated herein by reference.

### BACKGROUND ART

Polythiophene is a polymer with linked x-conjugated systems, providing electrical conductivity, excellent processability, and high environmental and thermal stability. Due to these properties, polythiophene has obtained attention in recent years as a material for electrical components. Examples include organic thin-film solar cells, organic thin-film transistors, photoelectric conversion materials, organic EL materials, diodes, triodes, electro-optical displays, reflective films, and nonlinear optical materials.

Various methods have been reported for producing polythiophene, but generally, one example includes a method of producing polythiophene by polymerizing thiophene using a polythiophene polymerization catalyst. One example of a method of producing poly(3,4-ethylenedioxythiophene) (PEDOT), which is a derivative of polythiophene, includes a method of producing PEDOT by oxidative polymerization of 3,4-ethylenedioxythiophene (EDOT) using an oxidizing agent suitable for oxidative polymerization of pyrrole, such as ferrous salt, alkali metal persulfate, or ammonium persulfate, in an aqueous solution of polystyrene sulfonic acid (e.g., Patent Document 1). Since PEDOT is insoluble, PEDOT is obtained in the above production method as a colloidal particle dispersion. In addition, an example of a method of forming a thin-film of PEDOT includes directly polymerizing an EDOT monomer with an oxidative polymerization agent such as ferrous salt of p-toluenesulfonic acid, along with a low-temperature curing binder and a solvent on a supporting substrate (e.g., Patent Document 1). A method of forming a film from a liquid containing EDOT raw material is a gelation film-forming method, a drop-casting method, a spin-coating method, and the like. The thickness of the PEDOT thin film obtained by this film formation method is in the range of several tens of nanometers (nm) to several hundreds of nanometers to several micrometers (μm) (e.g., Non-Patent Document 1 and Patent Document 2).

On the other hand, various methods for the production of nanosheet-like particles have been studied. For example, a method has been disclosed in which metal-organic framework nanosheet-like particles are produced by forming a sheet-like metal-organic framework between two monolayers constituting a single bilayer membrane when the bilayer membrane forms a hyper-swollen lamellar phase in a solvent (e.g., Patent Document 3). Also, for example, a method has been disclosed in which zeolite nanosheet-like particles are produced by forming a zeolite precursor (aluminosilicate) between two monolayers constituting one bilayer membrane when the bilayer membrane forms a hyper-swollen lamellar phase in a solvent (e.g., Patent Document 4).

### PATENT DOCUMENTS

Patent Document 1: Japanese Unexamined Patent Application Publication No. H01-
Patent Document 2: Japanese Unexamined Patent Application Publication No. 2011-181724
Patent Document 3: International Publication No. 2018/016650
Patent Document 4: International Publication No. 2020/250985

### Non-Patent Literature

Non-Patent Document 1: Proceedings of the 65th Japan Society Applied Physics Spring Meeting (2018, Waseda University, Nishi-Waseda Campus), Lecture Number: 18p-P3-11

### SUMMARY OF INVENTION

### Technical Problem

However, in the method of forming a thin film by directly polymerizing a formed-solution-layer containing EDOT raw materials, it is difficult to achieve a thin film with a thickness of 10 nm or less. Additionally, and there are also problems that these methods require expensive equipment.

Furthermore, Patent Documents 3 and 4 do not disclose a method of forming nanosheet-like particles of a polymer such as PEDOT by polymerizing a formed-solution-layer containing EDOT raw materials. In particular, there is no disclosure regarding a method of forming nanosheet-like particles of polythiophene-based compounds.

In view of the above circumstances, the present invention has an object to provide nanosheet-like particles of a polythiophene-based compound and a method for producing the same, and also to provide a dispersion liquid containing the nanosheet-like particles of a polythiophene-based compound.

### Solution to Problem

In order to solve the above problems, the present invention provides the following means.
[1] A nanosheet-like particle, which is a nanosheet-like particle of a polythiophene-based compound, wherein a thickness of the nanosheet-like particle is 0.5 nm or more and 10 nm or less, and
an aspect ratio of the nanosheet-like particle is 100 or more.
[2] The nanosheet-like particle according to [1], wherein the polythiophene-based compound is poly(3,4-ethylenedioxythiophene).
[3] The nanosheet-like particle according to [1] or [2], wherein a thickness of the nanosheet-like particle is 1 nm or more and 5 nm or less, and a width of the nanosheet-like particle in a planar direction is 200 nm or more and 100 μm or less.
[4] A method for producing a nanosheet-like particle of a polythiophene-based compound, comprising:
a first step of forming a layer of a thiophene-based compound between two monomolecular phases constituting one bilayer membrane
by forming a hyper-swollen lamellar phase of the bilayer membrane which is formed by forming a bilayer membrane in a solvent, and adding a thiophene-based compound to the solvent; and
a second step of forming the nanosheet-like particle of a polythiophene-based compound by oxidatively polymerizing the thiophene-based compound which formed a layer in the first step using a polymerization catalyst.
[5] The method for producing the nanosheet-like particle of the polythiophene-based compound according to [4], wherein in the first step, the hyper-swollen lamellar phase of the bilayer membrane is formed under a temperature condition of 20 °C or higher and 40 °C or lower.
[6] The method for producing the nanosheet-like particle of the polythiophene-based compound according to [4] or [5], wherein the thiophene-based compound is 3,4-ethylenedioxythiophene, and, the polythiophene-based compound is poly(3,4-ethylenedioxythiophene).
[7] The method for producing the nanosheet-like particle of the polythiophene-based compound according to [4] or [5], wherein the polymerization catalyst is iron (III) chloride.
[8] The method for producing the nanosheet-like particle of the polythiophene-based compound according to [4] or [5], wherein the solvent is a solvent consisting of only water or a mixed solvent containing a hydrocarbon solvent and water, and
a mass ratio of the hydrocarbon solvent to water in the solvent is hydrocarbon-based solvent:water=0:100 to 15:85.
[9] The method for producing the nanosheet-like particle of the polythiophene-based compound according to [4] or [5], wherein the solvent is a mixed solvent containing a hydrocarbon solvent and water, and
a mass ratio of the hydrocarbon solvent to water in the solvent is hydrocarbon solvent:water=0.01:99.99 to 15:85.
[10] The method for producing the nanosheet-like particle of the polythiophene-based compound according to [9], wherein the hydrocarbon solvent is hexane.
[11] The method for producing the nanosheet-like particle of the polythiophene-based compound according to [4] or [5], wherein the amphiphilic substance constituting the bilayer membrane is polyethylene glycol monoalkyl ether.
[12] The method for producing the nanosheet-like particle of the polythiophene-based compound according to [11], wherein the polyethylene glycol monoalkyl ether is tetraethylene glycol monomethyl ether.
[13] The method for producing the nanosheet-like particle of the polythiophene-based compound according to [11], wherein the polyethylene glycol monoalkyl ether is tetraethylene glycol monododecyl ether having a number average molecular weight of 362 or less.
[14] The method for producing the nanosheet-like particle of the polythiophene-based compound according to [4] or [5], wherein the solvent contains a monohydric alcohol.
[15] The method for producing the nanosheet-like particle of the polythiophene-based compound according to [14], wherein the monohydric alcohol is at least one selected from the group consisting of 1-propanol, 2-propanol and 1-butanol.
[16] The method for producing the nanosheet-like particle of the polythiophene-based compound according to [14], wherein the monohydric alcohol is 1-propanol.
[17] The method for producing the nanosheet-like particle of the polythiophene-based compound according to [15], wherein a content of the monohydric alcohol in the solvent is 0.1% by mass or more and 10% by mass or less.
[18] The method for producing the nanosheet-like particle of the polythiophene-based compound according to [4] or [5], wherein a thickness of the nanosheet-like particle is 0.5 nm or more and 10 nm or less,
a width of the nanosheet-like particle in a planar direction is 200 nm or more and 100 μm or less, and
an aspect ratio of the nanosheet-like particle (maximum width in the particle/thickness) is 100 or more.
[19] A dispersion composition comprising the nanosheet-like particle according to [1] or [2].
[20] The dispersion composition according to [19], which further comprises a monohydric alcohol, and which is substantially free of water.

### Advantageous Effects of Invention

According to the present invention, it is possible to provide nanosheet-like particles of a polythiophene-based compound with a thickness of 10 nm or less, which cannot be obtained by conventional methods, and a method for producing the same. In particular, it is possible to provide a dispersion composition containing nanosheet-like particles of a polythiophene-based compound that are stable without aggregation.

### BRIEF DESCRIPTION OF DRAWINGS

FIG. 1 shows AFM data of the nanosheet-like particles of a polythiophene-based compound obtained in Example A-1.

FIG. 2 shows AFM data of the nanosheet-like particles of the polythiophene-based compound obtained in Example A-1.

FIG. 3 is an FT-IR spectrum of the nanosheet-like particles of the polythiophene-based compound obtained in Example A-1.

FIG. 4 is a TEM image of the nanosheet-like particles of the polythiophene-based compound obtained in Example A-1.

FIG. 5 is a TEM image of the nanosheet-like particles of the polythiophene-based compound obtained in Example A-1.

FIG. 6 is a TEM image of the nanosheet-like particles of the polythiophene-based compound obtained in Example A-1.

FIG. 7 shows DLS data of the nanosheet-like particles of the polythiophene-based compound obtained in Example A-1.

FIG. 8 shows SEM-EDX data of the nanosheet-like particles of the polythiophene-based compound obtained in Example A-1.

FIG. 9 shows TG data of the nanosheet-like particles of the polythiophene-based compound obtained in Example A-1.

FIG. 10 shows AFM data of nanosheet-like particles of a polythiophene-based compound obtained in Example D-1.

FIG. 11 shows AFM data of the nanosheet-like particles of the polythiophene-based compound obtained in Example D-1.

FIG. 12 is a TEM image of the nanosheet-like particles of the polythiophene-based compound obtained in Example D-1.

FIG. 13 shows DLS data of the nanosheet-like particles of the polythiophene-based compound obtained in Example D-1.

FIG. 14 is a photograph showing the test results of the coating property of PEDOT nanosheet-like particles.

FIG. 15 is a photograph showing the test results of the coating property of PEDOT bulk particles.

FIG. 16 is a schematic diagram showing the coating property of PEDOT nanosheet-like particles.

FIG. 17 is a schematic diagram showing the coating property of PEDOT bulk particles.

FIG. 18 is a photograph showing the results of a test evaluating the effect of production conditions (pH) on the formation of PEDOT nanosheet-like particles.

FIG. 19 is a diagram showing the results of a test evaluating the effect of production conditions (pH) on the yield of PEDOT nanosheet-like particles.

FIG. 20 is a photograph showing the results of a test evaluating the effect of production conditions (addition of SDS) on the yield of PEDOT nanosheet-like particles.

### DESCRIPTION OF EMBODIMENTS

Hereinafter, the nanosheet-like particles of a polythiophene-based compounds and a method for producing the same according to an embodiment of the present invention will be described. It should be noted that the embodiment is provided to facilitate a better understanding of the essence of the invention through specific examples. However, unless otherwise specified, the embodiment does not limit the scope of the present invention.

### (Nanosheet-Like Particles of Polythiophene-Based Compound)

The nanosheet-like particles of a polythiophene-based compound according to one embodiment of the present invention (hereinafter referred to as nanosheet-like particles of the present embodiment) are nanosheet-like particles formed of a polythiophene-based compound. The nanosheet-like particles of the present embodiment have a thickness of 0.5 nm or more and 10 nm or less. The aspect ratio of the nanosheet-like particles is 100 or more. Here, the aspect ratio is defined as the ratio of the maximum width to the thickness in the particle (maximum width/thickness). The thickness of the nanosheet-like particles is preferably 1 nm or more and 5 nm or less. The width of the nanosheet-like particles in a planar direction may be 200 nm or more and 100 μm or less.

Furthermore, in this specification, the term “thiophene-based compound” as used herein refers to thiophene or its derivative (including, for example, thiophene which may have a substituent), and the term “polythiophene-based compound” means polythiophene or its derivative (including, for example, a polymer of the thiophene-based compound).

The nanosheet-like particles of the present embodiment exhibit excellent uniformity in thickness and aspect ratio, and due to their ultrathin nature, also have high flexibility and high adhesive strength.

The nanosheet-like particles of the present embodiment are not necessarily limited to those obtained by the “Method for Producing Nanosheet-Like Particles of Polythiophene-Based Compound” described below; however it is preferable that nanosheet-like particles have the same size, dispersion characteristics, or conductivity as those obtained by the “Method for Producing Nanosheet-Like Particles of Polythiophene-Based Compound” described below. More preferably, the nanosheet-like particles are those obtained by the “Method for Producing Nanosheet-Like Particles of Polythiophene-Based Compound” described below.

The nanosheet-like particles of the present embodiment are not limited in terms of the form (bulk state) in which they exist, and examples of such forms include states in which they are dispersed in a fluid medium, a powder state, a state of a thin film formed on a supporting substrate, and an independent sheet state.

The nanosheet-like particles of the present embodiment may exist in a monodispersed state before the solution is removed when produced by the “Method for Producing Nanosheet-Like Particles of Polythiophene-Based Compound” described later.

Alternatively, they may form secondary particles by aggregating (e.g., stacking) the nanosheet-like particles in the monodispersed state as primary particles. For example, it can be determined that the nanosheet-like particles are one nanosheet-like particle as a primary particle based on the measurement results of TEM and AFM shown in the examples described later.

The width of the nanosheet-like particles in the planar direction is not particularly limited, but may be 200 nm or more and 100 μm or less. In addition, for example, when produced by the “Method for Producing Nanosheet-Like Particles of Polythiophene-Based Compound” described later, the nanosheet-like particles in the monodispersed state (for example, those having a width in the planar direction of 200 nm or more and 100 μm or less) may be formed into a film on a substrate to form a nanosheet-like particle film. The nanosheet-like particles here are sheets having a thickness of 0.5 nm or more and 10 nm or less (preferably 1 nm or more and 5 nm or less), and the width in the planar direction may exceed 100 μm. The nanosheet-like particles of the present embodiment may include such nanosheet-like particles.

### [Polythiophene-Based Compound]

The polythiophene-based compound of one embodiment of the present invention (hereinafter referred to as the polythiophene-based compound of the present embodiment) is a polymer compound having a structure containing a polymer of a thiophene-based compound, and a polymer compound having thiophene as a partial skeleton. The degree of polymerization of the polythiophene-based compound of the present embodiment can be estimated by a method of estimating the degree of polymerization by assuming that one sheet of the nanosheet-like particle of the present embodiment is made of one molecule. For example, an example of the polythiophene-based compound of the present embodiment may be a polymer compound having a structure containing a polymer of a thiophene-based compound of 150,000-mers or more and 15,000,000-mers or less, and a polymer compound having thiophene as a partial skeleton. The thiophene-based compound is preferably at least one selected from the group consisting of thiophenes and their derivatives. The polythiophene-based compound of the present embodiment may be at least one polymer of compounds selected from the group consisting of the thiophenes and their derivatives, or at least one selected from the group consisting of polythiophenes and their derivatives.

Examples of the thiophene-based compounds according to the present embodiment include thiophene, 3-methylthiophene, 3-ethylthiophene, 3-propylthiophene, 3-butylthiophene, 3-hexylthiophene, 3-heptylthiophene, 3-octylthiophene, 3-nonylthiophene, 3-decylthiophene, 3-methoxythiophene, 3-ethoxythiophene, 3-butoxythiophene, 3-methyl-4-methoxythiophene, 3,4-ethylenedioxythiophene, benzothiophene, and benzodithiophene. Among these, 3,4-ethylenedioxythiophene (EDOT) is preferred due to its moderate polymerization rate and excellent heat resistance of the resulting polymer thereof.

The polythiophene and its derivatives according to the present embodiment are preferably homopolymers. A homopolymer is a polymer in which multiple units selected from the group consisting of thiophenediyl groups and thiophenediyl groups having a substituent are repeatedly bonded together. Among the thiophenediyl groups, a thiophene-2,5-diyl group is preferred. Among the thiophenediyl groups having a substituent, a 3,4-ethylenedioxythiophene-2,5-diyl group and an alkylthiophene-2,5-diyl group are preferred. Specific examples of homopolymer polythiophenes and their derivatives include poly(3,4-ethylenedioxythiophene) (PEDOT), poly(3-hexylthiophene-2,5-diyl) (P3HT), poly(3-octylthiophene-2,5-diyl), poly(3-dodecylthiophene-2,5-diyl), and poly(3-octadecylthiophene-2,5-diyl). Among the homopolymer polythiophenes and their derivatives, polythiophene homopolymers composed of thiophene-diyl groups substituted with a 3,4-ethylenedioxy group or an alkyl group containing 6 to 30 carbon atoms are preferred, and poly(3,4-ethylenedioxythiophene) (PEDOT), represented by the following formula (A), is more preferred.

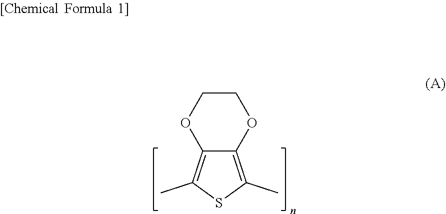

### (Method for Producing Nanosheet-Like Particles of Polythiophene-Based Compound)

A method for producing nanosheet-like particles of a polythiophene-based compound according to one embodiment of the present invention (hereinafter referred to as the present embodiment) includes a first step of forming a layer of a thiophene-based compound, which is a monomer of the polythiophene-based compound, and a second step of oxidatively polymerizing the thiophene-based compound in the layer of the thiophene-based compound to produce nanosheet-like particles of the polythiophene-based compound.

Here, the “polythiophene-based compound” and the “thiophene-based compound” are the same as the “polythiophene-based compound” and the “thiophene-based compound” described in the above section (Nanosheet-Like Particles of Polythiophene-Based Compound). The preferred examples are also the same.

### <First Step>

In the first step, a layer of a thiophene-based compound, which is a monomer of a polythiophene-based compound, is formed using a hyper-swollen lamellar phase.

A bilayer membrane is formed in a solvent, and the thiophene-based compound is added to the solvent to induce a hyper-swollen lamellar phase of the bilayer membrane. As a result, a layer of the thiophene-based compound is formed between the two monomolecular phases that constitute one of the bilayer membranes. That is, by forming a hyper-swollen lamellar phase of the bilayer membrane, the thiophene-based compound can be trapped between the two monomolecular phases that constitute one of the bilayer membranes. As a result, a layer of the thiophene-based compound is formed between the two monomolecular phases that constitute one of the bilayer membranes.

In the layer of the thiophene-based compound formed between the two monomolecular phases, for example, the monomer molecules of the thiophene-based compound contained in the layer of the thiophene-based compound are present in a hyper-swollen lamellar phase in a substantially non-aggregated state. The molecules of the thiophene-based compound may be arranged within a thin two-dimensional planar space formed between the two monomolecular phases. The molecules of the thiophene-based compound in the thin two-dimensional planar space may have a specific orientation or a random orientation. In addition, one layer of the thiophene-based compound formed between a pair of the two monomolecular phases may be arranged in a thickness direction of the layer with other layers of the thiophene-based compound, which is formed in the same manner, to form a laminated structure.

The layer of the thiophene-based compound thus formed between the two monomolecular phases imparts high orientation to the “polythiophene-based compound” (i.e., the nanosheet-like particles of the present embodiment) obtained after the subsequent polymerization in the arrangement state of the polythiophene-based compound and has the effect of suppressing the insulating effect due to intermolecular spacing (i.e., the effect of exhibiting high electrical conductivity). As a result, the “polythiophene-based compound” (i.e., the nanosheet-like particles of the present embodiment) obtained after polymerization exhibits excellent uniformity in thickness and aspect ratio, as well as high flexibility and strong adhesion due to its thinness.

Furthermore, a “polythiophene-based compound” (i.e., the nanosheet-like particle of the present embodiment) is formed through a subsequent polymerization reaction from the layer of the thiophene-based compound formed between the two monomolecular phases (monomer layer). Since the space for the polymerization reaction is restricted, the growth of the polymer is expected to occur primarily in the planar direction. In addition, in consideration of the physical properties of the polythiophene-based compound, a single nanosheet-like particle may be formed from one polymer. In addition, one nanosheet-like particle may be formed from a stack of multiple polymer molecules. In the nanosheet-like particle, the state and arrangement of the polymer of the polythiophene-based compound are not limited to the state and arrangement of the polymer in the nanosheet-like particle when the nanosheet-like particle of the present embodiment contains a polythiophene-based compound and is the above-mentioned nanosheet-like particle.

In the present embodiment, a hyper-swollen lamellar phase is first formed, and then a thiophene-based compound is added. Another example of a method for forming a hyper-swollen lamellar phase may include a method in which a bilayer membrane is formed in a solvent, and an amphiphilic substance is added to the solvent to form a hyper-swollen lamellar phase of the bilayer membrane.

The hyper-swollen lamellar phase refers to a specific lamellar phase swollen with a solvent. More specifically, it refers to a phase in which a plurality of bilayer membranes constituting the lamellar phase are stacked in layers with a layer of solvent sandwiched between them.

The phase constituting the hyper-swollen lamellar phase may be observed to exhibit coloration due to Bragg reflection in the visible light region. The hyper-swollen lamellar phase may be a hyper-swollen lyotropic lamellar phase.

In the hyper-swollen lamellar phase, the mass ratio of the solvent to the whole is not particularly limited as long as the object of the present invention is satisfied, but is usually 90 mass % or more, preferably 95 mass % or more, more preferably 98 mass % or more, and even more preferably 99 mass % or more. The upper limit is not particularly limited as long as the hyper-swollen lamellar phase can be formed between the solute and the solvent, and the theoretical upper limit is the limit concentration at which the hyper-swollen lamellar phase can be formed between the solvents used. The above-mentioned “the whole” means the total of all the mixtures including the solute and the solvent. In the hyper-swollen lamellar phase, the upper limit of the mass ratio of the solvent to the whole can be, for example, 99 mass %.

In the hyper-swollen lamellar phase, the distance between adjacent bilayer membranes (hereinafter referred to as “interlayer distance” in this specification) is not particularly limited and can be appropriately set depending on the materials used and the intended application. It is usually 50 nm or more and 1000 nm or less (including both values, the same below). When the intended nanosheet-like particle is to be thinned, the interlayer distance is preferably thin, for example, preferably 500 nm or less. The interlayer distance between bilayer membranes means the distance from the end of a first bilayer membrane's part that has affinity for the solvent to the end of a part of a second bilayer membrane that is adjacent to the first bilayer membrane and wherein the part has affinity for the solvent. The interlayer distance may also depend on the content of the molecules (amphiphilic molecules) that constitute the bilayer membrane.

The thickness of the bilayer membrane itself is not particularly limited, but is usually 1 nm to 20 nm, preferably 1 nm to 10 nm, and more preferably 1 nm to 5 nm.

The hyper-swollen lamellar phase remains stable even in solutions containing non-ionic amphiphiles due to the waviness of the individual layers, or Helfrich interactions.

By confining thiophene-based compounds within a bilayer of hyper-swollen lamellar phases, layers of thiophene-based compounds can be produced, and in particular ordered layers of thiophene-based compounds can be produced.

After forming the hyper-swollen lamellar phase, a thiophene-based compound is added to the solvent to form a layer of the thiophene-based compound between the two monolayers that constitute one of the bilayer membranes.

In the method for forming a layer of the thiophene-based compound, the hydrophilic part faces the solvent side, and thus a layer of the thiophene-based compound is formed between the hydrophobic parts of two monolayers constituting one bilayer membrane. By changing the combination of the solvent and amphipathic molecules to be mixed, the hydrophobic part and the hydrophilic part of the bilayer membrane are arranged as described above. In the present embodiment, since a layer of the thiophene-based compound is formed between parts that are not compatible with the solvent, a layer of the thiophene-based compound can be produced not only in a hydrophobic reaction field but also in a hydrophilic reaction field, depending on the type of solvent used.

### <Solvent>

In the present embodiment of the method for producing a layer of a thiophene-based compound, the solvent may be composed solely of water, but preferably contains an organic solvent other than water. The organic solvent may be a hydrocarbon solvent.

Examples of hydrocarbon solvents include aliphatic hydrocarbon solvents such as cyclohexane, methylcyclohexane, n-pentane, n-hexane, n-heptane, n-octane, n-nonane, n-decane, n-dodecane, bicyclohexyl; and aromatic hydrocarbon solvents such as toluene, xylene, mesitylene, ethylbenzene, n-hexylbenzene, cyclohexylbenzene. The solvent may consist solely of a hydrocarbon solvent, or it may be a mixture of the hydrocarbon solvent and another organic solvent.

Examples of the other organic solvent include ketone-based solvents such as acetone, acetylacetone, methyl ethyl ketone, cyclohexanone, and acetophenone; alcohol-based solvents such as methanol, ethanol, n-propanol, isopropyl alcohol, cyclohexanol, ethylene glycol, diethylene glycol, propylene glycol, and glycerol; chlorine-based solvents such as 1,2-dichloroethane, 1,1,2-trichloroethane, chlorobenzene, and o-dichlorobenzene; and ether-based solvents such as tetrahydrofuran, dioxane, anisole, and 4-methylanisole.

When a hydrocarbon solvent and another organic solvent are used as the solvent, the mass ratio of the two (hydrocarbon solvent:other organic solvent) is preferably 80:20 to 99.99:0.01, and more preferably 85:15 to 99.9:0.1.

In addition, as the solvent in the present embodiment of the method for producing a layer of a thiophene-based compound, for example, when the solvent is a solvent consisting of only water or a mixed solvent containing the organic solvent and water, the mass ratio of organic solvent to water is preferably 0:100 to 15:85, and more preferably 0:100 to 10:90. In addition, when the solvent is a mixed solvent containing the organic solvent and water, the mass ratio of the two is preferably organic solvent:water=0.01:99.99 to 15:85, and more preferably 0.1:99.9 to 10:90. In addition, in these preferred embodiments, as the solvent, instead of water or in addition to water, an acidic aqueous solution such as hydrochloric acid, nitric acid, or sulfuric acid; or a basic aqueous solution such as a sodium hydroxide aqueous solution may be used depending on the type of reaction in synthesizing the target nanosheet-like particles.

In the present embodiment, the organic solvent is preferably a hydrocarbon solvent. The solvent is preferably a mixture of water and a hydrocarbon solvent, and more preferably a mixture of water and hexane. The mass ratio of the two is preferably hexane:water=0.01:99.99 to 15:85, and more preferably 0.1:99.9 to 10:90.

### <Amphiphilic Substance>

In the present embodiment, the amphiphilic substance may be, for example, a nonionic amphiphilic substance.

The amount of the amphiphilic substance added may be 1 to 50 parts by mass, 1 to 10 parts by mass, or 1 to 5 parts by mass, relative to 100 parts by mass of the solution (total amount including a surfactant co-agent, if any).

### “Nonionic Amphiphilic Substance”

Examples of the nonionic amphiphilic substance according to the present embodiment include ester type surfactants, ether type surfactants, ester ether type surfactants, alkanolamide type surfactants, alkyl glycosides, and higher alcohols. Commercially available nonionic amphiphilic substances can be used.

Examples of ester-type surfactants include sucrose fatty acid esters such as sucrose laurate, sucrose oleate, and sucrose monopalmitate;
sorbitan fatty acid esters such as sorbitan monocaprylate, sorbitan dicaprylate, sorbitan monocaproate, sorbitan dicaproate, sorbitan monocaprate, sorbitan dicaprate, sorbitan monolaurate, sorbitan dilaurate, sorbitan monomyristate, and sorbitan dimyristate;
monoglycerol fatty acid esters such as glyceryl caprylate, glyceryl caprate, glyceryl laurate, glyceryl myristate, and glyceryl di (laurate/myristate); and
polyglycerol fatty acid esters such as diglyceryl monostearate, diglyceryl monooleate, diglyceryl dioleate, diglyceryl monoisostearate, tetraglyceryl monostearate, tetraglyceryl tristearate, tetraglyceryl pentastearate, tetraglyceryl pentaoleate, hexaglyceryl monolaurate, hexaglyceryl monomyristate, hexaglyceryl stearate, hexaglyceryl monostearate, hexaglyceryl monooleate, hexaglyceryl tristearate, hexaglyceryl pentastearate, hexaglyceryl pentastearate, hexaglyceryl polyricinoleate, decaglyceryl monolaurate, decaglyceryl monomyristate, decaglyceryl monostearate, decaglyceryl monooleate, decaglyceryl monolinoleate, decaglyceryl monoisostearate, decaglyceryl distearate, decaglyceryl dioleate, decaglyceryl diisostearate, decaglyceryl tristearate, decaglyceryl trioleate, decaglyceryl triisostearate, decaglyceryl pentastearate, decaglyceryl pentaoleate, decaglyceryl pentaisostearate, decaglyceryl heptastearate, decaglyceryl heptaoleate, decaglyceryl heptaisostearate, decaglyceryl decastearate, decaglyceryl decaoleate, and decaglyceryl decaisostearate.

Examples of the ether type surfactant include polyethylene glycol monoalkyl ethers such as polyethylene glycol monoalkyl ethers (CnEm) represented by the following formula (1).

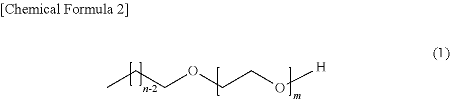

(In the formula, n represents the number of carbon atoms in the alkyl group of the hydrophobic part, and m represents the number of ethylene oxide units in the hydrophilic part. And, n may be 3 to 40, 5 to 20, or 20 to 14; and m may be 1 to 10, 2 to 8, or 3 to 6.)
polyoxyethylene alkylphenyl ethers such as poly(oxyethylene) octylphenyl ether represented by the following formula (2),

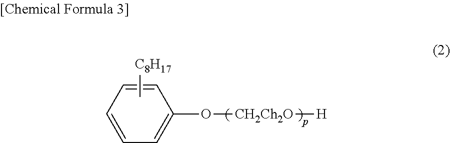

(In the formula, the number of added moles of ethylene oxide, p, may be 3 to 40, or 5 to 20.)
poly(oxyethylene) nonylphenyl ether represented by the following formula (3),

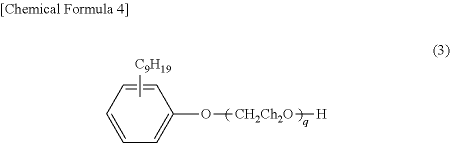

(In the formula, the number of added moles of ethylene oxide, q, may be 3 to 40, or 5 to 20.)

Examples of ester ether type surfactants include polyoxyethylene fatty acid esters such as polyethylene glycol monostearate, polyethylene glycol monooleate, and polyethylene glycol dioleate; polyoxyethylene hexitane fatty acid esters; polyoxyethylene sorbitan fatty acid esters (where the sorbitan fatty acid ester part is the same as the above-mentioned ester type surfactants); and sorbitan fatty acid ester polyethylene glycol (where the sorbitan fatty acid ester part is the same as the above-mentioned ester type surfactants).

Examples of alkanolamide surfactants include fatty acid alkanolamides such as lauric acid monoethanolamide, lauric acid monoisopropanolamide, lauric acid diethanolamide, oleic acid diethanolamide, stearic acid diethanolamide, and cocamide DEA (cocamide diethanolamine).

Examples of alkyl glycosides include n-octyl-β-D-glucoside, n-octyl-β-D-maltoside, n-decyl-β-D-glucoside (decyl glucoside), n-decyl-β-D-maltoside, n-undecyl-β-D-glucoside, n-dodecyl-β-D-glucoside (lauryl glucoside), n-tridecyl-β-D-glucoside, n-octadecyl-β-D-glucoside, n-heptyl-β-D-thioglucoside, n-octyl-β-D-thioglucoside, and n-nonyl-β-D-thiomaltoside.

Examples of higher alcohols include higher alcohols having 12 to 18 carbon atoms, such as cetanol, stearyl alcohol, lauryl alcohol, and oleyl alcohol.

In a preferred embodiment, the nonionic amphiphilic substance may be composed of polyethylene glycol monoalkyl ether (CₙEₘ) represented by the following formula (1),

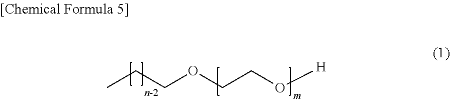

(In the formula (1), n and m have the same meanings as above.)

Examples of the polyethylene glycol monoalkyl ethers include tetraethylene glycol monomethyl ether and tetraethylene glycol monododecyl ether.

In an embodiment, in the above formula (1), 2<n/m<6, 2.2<n/m<5, or 2.4≤n/m≤4. The lower limit of n/m is not particularly limited, but may be 2, 2.2, or 2.4. The upper limit of n/m is not particularly limited, but may be 6, 5, 4, or 3. The nonionic amphiphilic substance according to the present embodiment is preferably tetraethylene glycol monododecyl ether (C₁₂E₄). An example of tetraethylene glycol monododecyl ether (C₁₂E₄) includes polyethylene glycol dodecyl ether (Brij (registered trademark) L4, manufactured by Sigma-Aldrich) used in the examples described later.

### [Surfactant Co-Agent]

In the present embodiment, the solvent may contain a surfactant co-agent to stabilize the amphiphilic substance. Examples of the surfactant co-agent include monohydric alcohol, glycol-based polyhydric alcohol and their derivatives. In the present embodiment, it is particularly preferable that the solvent contains a monohydric alcohol.

Examples of monohydric alcohols include monohydric alcohol having 1 to 10 carbon atoms such as ethanol, n-propanol, isopropanol, n-butanol, sec-butanol, isobutyl alcohol, tert-butyl alcohol, 1-pentanol, 2-pentanol, 3-pentanol, 2-methyl-1-butanol, isopentyl alcohol, tert-pentyl alcohol, 3-methyl-2-butanol, neopentyl alcohol, 1-hexanol, 1-heptanol, 1-octanol, 1-nonanol, 1-decanol, 2-methyl-1-pentanol, 4-methyl-2-pentanol, 2-ethyl-1-butanol, 2-heptanol, 3-heptanol, 2-octanol, 2-ethyl-1-hexanol, and 3,5,5-trimethyl-1-hexanol; and
cholesterols and their derivatives such as cholesterol, cholesteryl alkenylsuccinate, cholestanol, cholesteryl esters having a saturated or unsaturated, linear or branched hydrocarbon group having 12 to 36 carbon atoms (preferably 14 to 28 carbon atoms), and dehydrocholesterol.

Examples of glycol-based polyhydric alcohols or their derivatives include glycol ethers such as ethylene glycol monomethyl ether, ethylene glycol monoethyl ether, ethylene glycol monobutyl ether, propylene glycol 1-methyl ether, ethylene glycol diethyl ether, ethylene glycol dimethyl ether, diethylene glycol monomethyl ether, diethylene glycol monoethyl ether, diethylene glycol monobutyl ether, diethylene glycol dimethyl ether, diethylene glycol diethyl ether, and triethylene glycol dimethyl ether;
glycol ether acetates such as ethylene glycol methyl ether acetate and diethylene glycol ethyl ether acetate;
diols such as ethylene glycol, propylene glycol, 1,3-butylene glycol, diethylene glycol, dipropylene glycol, and hexylene glycol; and
polyols such as glycerol, pentaerythritol, and sorbitol.

In the present embodiment, the solvent is a mixed solvent of a hydrocarbon solvent such as hexane and water, the amphiphilic substance is a nonionic amphiphilic substance such as polyethylene glycol monoalkyl ether (CnEm), and the solvent may further contain a surfactant co-agent such as a monohydric alcohol.

The thiophene-based compound layer according to the present embodiment may contain other compounds.

The temperature for forming the hyper-swollen lamellar phase in the present embodiment is preferably 15 °C to 60 °C, more preferably 20 °C to 40 °C, even more preferably 25 °C to 35 °C, and most preferably 28 °C to 32 °C.

In the first step according to the present embodiment, the pH of the system for forming the hyper-swollen lamellar phase of the bilayer membrane may be controlled in advance. For example, a buffer solution previously adjusted to a desired pH may be used instead of water as a solvent. The pH of the mixture solution within the system may be, for example, preferably a value within the range of 2 to 7. More preferably, the pH is within the range of 2 to 4.

In the first step according to the present embodiment, sodium dodecyl sulfate (hereinafter, referred to as SDS) may be added to the system for forming the hyper-swollen lamellar phase of the bilayer membrane. For example, the concentration of SDS in the mixed solution in the system is preferably 0.15% by mass or less.

### Specific Example of the First Step

A preferred example of the first step of the manufacturing method of the present embodiment will be described.

The reagents and conditions used are as follows.

Thiophene-based compounds: for example, 3,4-ethylenedioxythiophene (EDOT)
Solvent: for example, water or a mixture of hexane and water
Surfactant co-agent: 1-propanol
Amphiphilic substances: for example, tetraethylene glycol monododecyl ether (C₁₂E₄)
Formation temperature: for example, 25 °C to 35 °C.
Stirring time: for example, 15 to 30 hours
Stirring speed: for example, 100 to 500 rpm

First, a thiophene-based compound, an amphipathic substance, a surfactant co-agent, and a solvent are mixed. The order of mixing the reagents is not particularly limited, but for example, the order may be thiophene-based compound, amphipathic substance, surfactant co-agent, and solvent. The resulting mixture is then stirred at a predetermined stirring temperature. The stirring speed may vary depending on the stirring device, but for example, when a hot stirrer is used, it may be 100 to 500 rpm or 200 to 400 rpm.

In the mixed solution, the added amounts of each reagent are, for example, as follows.

The thiophene-based compound may be present in an amount of 0.05 to 0.5% by mass, or in an amount of 0.10 to 0.2% by mass.

The amphiphilic substance may be 2.5 to 7.5% by mass, or 4.0 to 5.0% by mass.

The solvent may be 5.0 to 8.0% by mass, or 6.0 to 7.0% by mass.

Water may be 70.0 to 95.0% by mass, or may be 86.0 to 90.0% by mass.

The thickness of the thiophene-based compound layer can be adjusted by appropriately combining conditions such as the thickness of the bilayer membrane, the composition ratio of raw materials, the reaction temperature, or the reaction time. In addition, for example, the formation of the hyper-swollen lamellar phase can be verified using a polarizing plate to observe the texture characteristic of the phase.

### <Second Step>

In the second step according to the present embodiment, an oxidative polymerization catalyst is added to the solution as a polymerization catalyst to oxidatively polymerize the thiophene-based compound, thereby producing nanosheet-like particles of a polythiophene-based compound.

### [Polymerization Catalyst]

The polymerization catalyst according to the present embodiment is not particularly limited as long as it can polymerize the thiophene-based compound in the layer of the thiophene-based compound obtained in the first step to synthesize a polythiophene-based compound. As the polymerization catalyst according to the present embodiment, for example, an oxidative polymerization catalyst is preferable. Examples of the oxidative polymerization catalyst include known oxidizing agents such as iron (III) chloride, iron p-toluenesulfonate, copper perchlorate, palladium acetate, and copper acetate.

In the second step according to the present embodiment, the reaction conditions for synthesizing a polythiophene-based compound using a polymerization catalyst are not particularly limited, but the following ranges are preferable.

Reaction temperature: may be 25 to 40 °C, or may be 30 to 35 °C.

The added amount of the polymerization catalyst may be, for example, 0.05 to 0.2 parts by mass, or 0.075 to 0.12 parts by mass, relative to 100 parts by mass of the mixed liquid obtained in the first step.

In the second step according to the present embodiment, the polymerization reaction time may be 8 to 48 hours, or 12 to 24 hours. Completion of the polymerization reaction can be confirmed by infrared spectroscopy.

In the second step according to the present embodiment, the pH of the reaction field for oxidatively polymerizing the thiophene-based compound that has formed a layer using a polymerization catalyst may be controlled in advance. For example, a buffer solution previously adjusted to a desired pH may be used instead of water as a solvent. The pH of the mixture that serves as the reaction field may be, for example, a value in the range of 2 to 7. Preferably, the pH of the mixture is in the range of 2 to 4.

By lowering the pH of the reaction field, the redox potential of the oxidizing agent (e.g., Fe³⁺) used as a polymerization catalyst increases, and it is expected that the oxidizing power of the oxidizing agent will be enhanced, and thereby the oxidative polymerization will be promoted.

In the second step according to the present embodiment, SDS may be added to a reaction field for oxidatively polymerizing the thiophene-based compound that has formed a layer using a polymerization catalyst. For example, the concentration of SDS in the mixture used as the reaction field is preferably 0.15% by mass or less.

When a small amount of SDS is present in the reaction field, it is expected that the electrostatic attraction of the SDS will attract the oxidizing agent (e.g., Fe 3+) used as a polymerization catalyst, thereby accelerating the oxidative polymerization.

### <Third Step>

The method for producing nanosheet-like particles of the present embodiment preferably further includes a third step.

In the third step, the solution containing the nanosheet-like particles obtained in the second step is dried by removing the solvent. The resulting dry solid may be a powder, granule, or other shaped body, or may be supported on a substrate. To make the dry solid into granules, a known granulation method such as extrusion, spray drying, stirring granulation, or rolling granulation may be used.

For example, the solvent, the surfactant co-agent, the amphiphilic substance, or the polymerization catalyst added in the first step can be removed by centrifugation. Ethanol and water are used as the solvents used for washing. The added solvent, water, surfactant co-agent, and amphiphilic substance are removed with ethanol, and the polymerization catalyst is removed with water. After washing, the nanosheet-like particles of the present embodiment may be dispersed in ethanol or the like without drying. Alternatively, the particles may be dried. In that case, the particles may be left to stand in an oven set at a certain drying temperature to remove the solvent. The drying temperature may be adjusted appropriately in relation to the drying time, and is not particularly limited as long as the particles are dried. For example, the temperature may be 50 to 95 °C, or 80 to 95 °C.

In the nanosheet-like particles of the present embodiment thus obtained, it is more preferable that the polythiophene-based compound is arranged in a high molecular orientation so as to have high orientation and suppress the insulating effect caused by the presence of spaces between molecules (i.e., to exhibit high electrical conductivity). Such nanosheet-like particles have excellent uniformity in thickness and aspect ratio, and also have high flexibility and strong adhesion due to their thinness.

Incidentally, when conventional film formation methods such as drop casting and spin coating are used and the surface microstructure of nanosheet-like particles of a thiophene-based compound after film formation is observed as an STM image, the layer of the thiophene-based compound often exhibits a random granular structure, weak orientation, or variations depending on the location.

### (Dispersion Composition Containing Nanosheet-Like Particles of Polythiophene-Based Compound)

The dispersion composition containing the nanosheet-like particles of the polythiophene-based compound according to one embodiment of the present invention (the dispersion composition of the present embodiment) is a dispersion composition containing the nanosheet-like particles of the polythiophene-based compound described above. Alternatively, the dispersion composition of the present embodiment is a dispersion composition containing the nanosheet-like particles of the polythiophene-based compound obtained by the method for producing nanosheet-like particles of the polythiophene-based compound.

The dispersion composition of the present embodiment preferably further contains a monohydric alcohol and is substantially free of water. Here, “substantially free of water” means that the dispersion composition contains 10% by mass or less, preferably 5% by mass or less, and more preferably 2% by mass or less of water. In addition, the dispersion composition may contain 0.0001% by mass (1 ppm) or more of water. Specific examples of the monohydric alcohol include the same monohydric alcohols described in the method for producing nanosheet-like particles of the present embodiment. The monohydric alcohol contained in the dispersion composition of the present embodiment may be the same as or different from the monohydric alcohol used as a surfactant co-agent in the method for producing nanosheet-like particles of the present embodiment.

In the dispersion composition of the present embodiment, the content of the nanosheet-like particles of the present embodiment may be 0 to 100% by mass, or may be 0 to 1% by mass.

An example of a method for producing the dispersion composition of the present embodiment is a method in which a monohydric alcohol is added to a solution containing nanosheet-like particles obtained after the second step of the method for producing nanosheet-like particles of the present embodiment described above, and then water is removed from the solution.

### [Applications of Nanosheet-Like Particles]

The nanosheet-like particles of the present embodiment can be used, for example, as conductive polymer nanosheet materials, thermoelectric conversion thin film materials, organic strain sensors, vital signs monitors, and the like.

### <Conductive Polymer Nanosheet Material>

Specific examples of the application as the conductive polymer nanosheet material include products such as antistatic films, solid electrolytic capacitors and organic electroluminescence, and fields such as organic solar cells, organic transistors and transparent electrodes. Incidentally, the electrical conductivity is, for example, from 0.1 S/cm to 10,000 S/cm, preferably from 1 S/cm to 1,000 S/cm.

### <Thermoelectric Conversion Thin Film Materials>

Specific examples of applications as thermoelectric conversion thin film materials include adhesive thermoelectric generation sheets (e.g., utilizing exhaust heat from factory piping) and independent power sources for IoT sensors (e.g., utilizing exhaust heat from electrical appliances), which are sheets or fibers that take advantage of the flexible properties of the nanosheet-like particles. These applications are used as thermoelectric conversion materials that recover and reutilize a portion of the waste heat emitted into the atmosphere from everyday products such as automobiles and home appliances to large-scale facilities such as power plants and factories, converting it into electrical energy.

### <Organic Strain Sensor>

Specific examples of applications as organic strain sensors include sensors for measuring strain data on the surface of biological tissues, which are essential for accurately measuring the deformation of flexible biological tissues in the development of artificial organs that can replicate movements similar to human organs; and hybrid artificial organs that combine these sensors with cells and tissues.

### <Vital Signs Monitor>

Specific examples of applications as vital signs monitors include ultra-thin electrodes (i.e., electronic nano-bandages) that can be attached to the skin to measure bioelectrical signals (e.g., body temperature, pH, heart rate, and muscle potential); products such as independent power sources for wearable sensor devices (e.g., using body temperature) which are used not only in daily life but also in healthcare, medical fields, and sports applications; and fields such as next-generation wearable devices.

Although the preferred embodiment of the present invention has been described in detail above, the present invention is not limited to these specific embodiments, and may be modified and adapted in various ways within the scope and spirit of the invention as defined in the claims.

### EXAMPLES

The present invention will be further described in detail below through examples and comparative examples; however, it is not limited to these examples.

### (Evaluation Method)

### [AFM (Atomic Force Microscopy)]

Instrument: Veeco Instruments, product name: MMAFM-2
Measurement conditions: Room temperature and in atmospheric environment
Sample preparation: A few milligrams of the sample were added to ethanol and subjected to ultrasonic treatment to prepare an ethanol dispersion. The prepared dispersion was dropped onto a mica substrate. Excess dispersion was absorbed, and the sample was dried.

### [FT-IR (Fourier Transform Infrared Spectroscopy)]

Measurement conditions: Room temperature, in atmospheric environment
Instrument: Manufactured by JASCO Product name: FT/IR-4600
Sample preparation: The sample powder is fixed onto a metallic disk.

### [TEM (Transmission Electron Microscopy)]

Measurement conditions: 1×10⁻⁶ Pa
Device: Hitachi, product name: H-800
Sample preparation: A few milligrams of the sample is added to ethanol, and subjected to ultrasonic treatment to prepare an ethanol dispersion. The prepared dispersion is dropped onto a TEM microgrid and dried to prepare the sample.

### [DLS (Dynamic Light Scattering)]

Apparatus: Product name: ELSZ-2000, manufactured by Otsuka Electronics Co., Ltd.
Measurement conditions: Room temperature, in atmospheric enviroment
Sample preparation: A few milligrams of the sample are added to ethanol, and subjected to ultrasonic treatment to prepare an ethanol dispersion. Approximately 1.5 mL of the prepared dispersion is added to a plastic cuvette for DLS and measurement is performed.

### [Electrical Conductivity]

Device: ATTO Product name: CROSSPOWER500
Measurement conditions: Room temperature, in atmospheric air
Sample preparation: A few milligrams of the sample were added to ethanol and subjected to ultrasonic treatment to prepare an ethanol dispersion. The prepared dispersion was dropped onto a slide glass and dried.

### Example Calculation

0.0050 g of PEDOT nanosheet-like particles were dispersed in 2 g of 0.1M HCL solution. The mixture was ultrasonically stirred to prepare a dispersion. The dispersion was applied to a glass substrate by a drop cast method, and dried to obtain a polythiophene thin film. The electrical conductivity of the thus obtained 1 μm-thick thin film was evaluated using a small digital tester. The measurement result was 1 S/cm. As a result of comparison with commercially available PEDOT: PSS sample measured in the same manner, the electrical conductivity was calculated to be approximately 1 S/cm. The calculation method was a method in which the coated area was regarded as a rectangular parallelepiped with a height of 1 μm and a width of 1 cm, and the resistance was measured at 1 cm intervals.

### [SEM-EDX (Energy Dispersive X-ray Spectroscopy)]

Instrument: Manufactured by JEOL, product name: JCM-7000
Measurement Conditions: High vacuum
Sample preparation: Prepare a sample by adhering a powder sample onto a carbon tape.

### [TG (Thermogravimetric Analysis)]

Device: Shimadzu Corporation, product name: DTG-60
Measurement conditions: In nitrogen atmosphere
Sample preparation: A powder sample (20 mg) was placed in an aluminum cell.

### [Conductivity Measurement]

### “Preparation of Measurement Samples”

The PEDOT bulk particles and the PEDOT nanosheet-like particles were each dispersed in water to prepare an aqueous dispersion (concentration: 3.4×10⁻⁴ g/ml).

### “Measurement Method”

The obtained aqueous dispersion was dropped onto a comb-like electrode (Pt, 2 μm inter-comb gap, manufactured by PSS Corporation), and the electrode was then dried. After drying, the conductivity of the electrode was measured using an impedance analyzer (Model SI1260, manufactured by Toyo Technica Corporation).

### [Evaluation of Coating Properties]

### “Preparation of Measurement Samples”

The PEDOT bulk particles and the PEDOT nanosheet-like particles were each dispersed in water to prepare an aqueous dispersion (concentration: 3.4×10⁻⁴ g/ml).

### “Evaluation Method”

The obtained aqueous dispersion was dropped onto a comb-like electrode (Pt, 2 μm inter-comb gap), and the electrode was then dried. After drying, the electrode was visually observed with a BX-51 research system microscope (manufactured by Olympus Corporation).

Evaluation criteria: The coating property was assessed based on whether the particles were uniformly dispersed without voids, whether the thickness of the particles was approximately uniform, and whether the particles were in close contact with each other. If these conditions were met, the sample was considered to have excellent coating properties.

### Example A-1

### (Production of PEDOT Nanosheet-Like Particles)

### <First Step>

(That is, a first step of forming a bilayer membrane composed of tetraethylene glycol monododecyl ether having a number average molecular weight of 362 or less in water containing 1-propanol and having a content of the 1-propanol of 0.1% by mass or more and 10% by mass or less, adding 3,4-ethylenedioxythiophene to the solvent to form a hyper-swollen lamellar phase of the bilayer membrane under a temperature condition of 20 °C or more and 40 °C or less, and forming a layer of the 3,4-ethylenedioxythiophene between two monomolecular phases constituting one bilayer membrane.)

### <Reagents and Reaction Conditions>

EDOT (FUJIFILM Wako Pure Chemical Industries, Ltd., 0.13% by mass) 0.04 g
Deionized water (88.6% by weight) 27 g
1-propanol (manufactured by Fujifilm Wako Pure Chemical Industries, Ltd., 6.56% by mass) 2.0 g
Polyethylene glycol dodecyl ether (Brij L4, Sigma-Aldrich, 4.59% by weight) 1.4 g
Reaction temperature: 30 °C.
Stirring speed: 300 rpm

0.04 g of EDOT, 1.4 g of Brij (registered trademark) L4, 2.0 g of 1-propanol, and 27 g of water were added to a 50 ml screw tube in measured amounts. The mixture was then stirred at 30 °C and 300 rpm. The texture derived from the hyper-swollen lamellar phase was confirmed with a polarizing plate, and a mixture having a hyper-swollen lamellar phase was obtained.

### <Second Step>

(That is, a second step of oxidatively polymerizing the 3,4-ethylenedioxythiophene contained in the 3,4-ethylenedioxythiophene layer using iron (III) chloride to form nanosheets of poly(2,3-dihydrothieno-1,4-dioxin).)

### <Reagents and Reaction Conditions>

Deionized water (3 ml)
FeCl₃·6H₂O (manufactured by Fujifilm Wako Pure Chemical Industries, Ltd.) 0.0039 g
Reaction temperature: 30 °C.
Reaction time: 24 hours

It was confirmed that the reaction occurred while maintaining the bilayer membrane.

3 ml of an aqueous solution of iron chloride was prepared using 0.0039 g of iron (III) chloride. The mixed solution obtained in the first step was heated to 30 °C, and 3 ml of the aqueous solution of iron (III) chloride was added dropwise to the mixed solution at 30 °C using a pipette.

### <Third Step>

(That is, a third step of removing the solvent from the solution containing the nanosheet-like particles obtained in the second step and drying the solution)

The solvent, water, polymerization catalyst, surfactant co-agent, and amphipathic substance added in the first and second steps were removed by centrifugation. Ethanol and water were used as the solvents for washing. The added solvent, water, surfactant co-agent, and amphipathic substance were removed with ethanol, and the polymerization catalyst was removed with water. After washing, the product may be stored as a dispersion in ethanol or the like without drying. Alternatively, drying may be performed by placing the sample in an oven set at 90 °C to evaporate the solvent.

### <Evaluation Results>

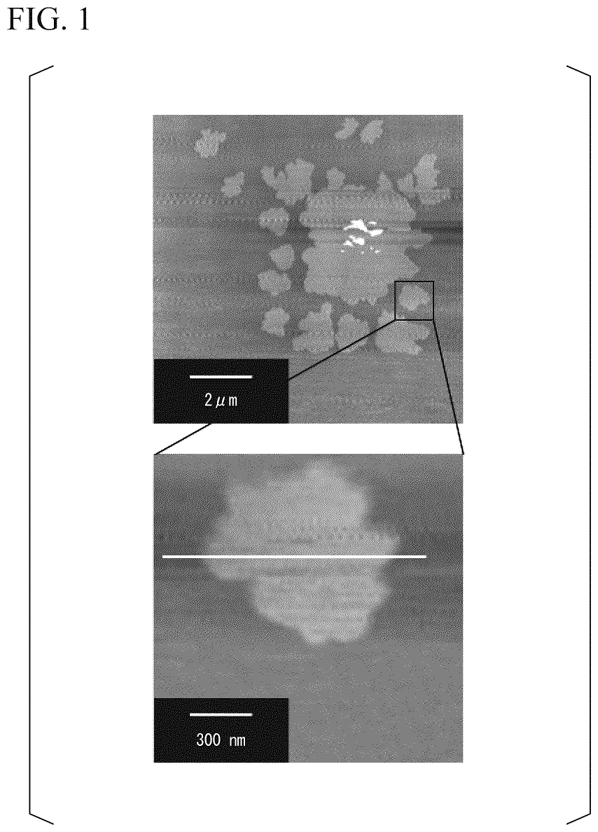

AFM results are shown in FIGS. 1 and 2.

The AFM measurement results showed that the thickness was 2 nm, the maximum planar width was 800 nm, and the aspect ratio (maximum width in the particle/thickness) was 600.

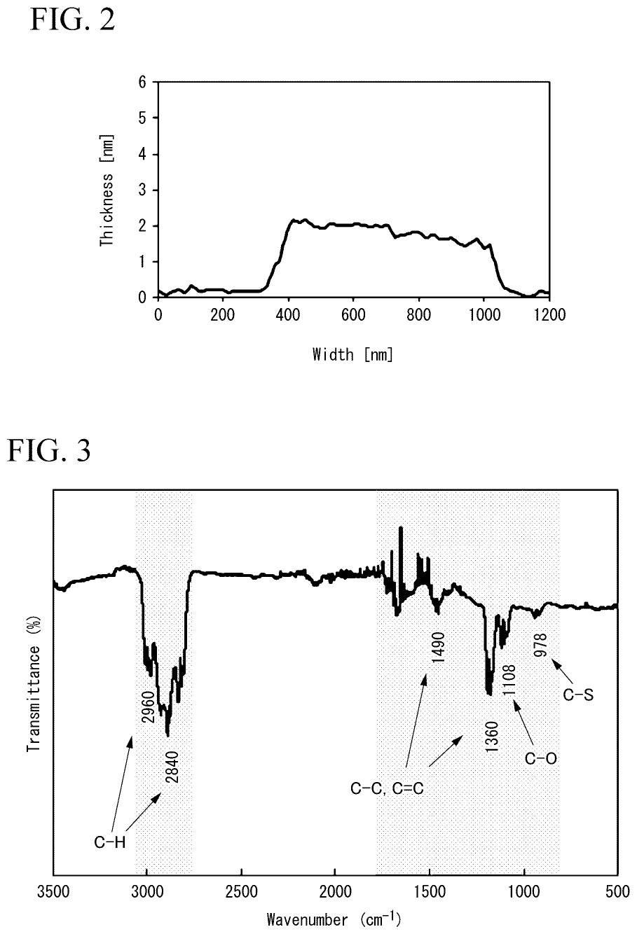

FT-IR results are shown in FIG. 3. A peak derived from PEDOT was confirmed.

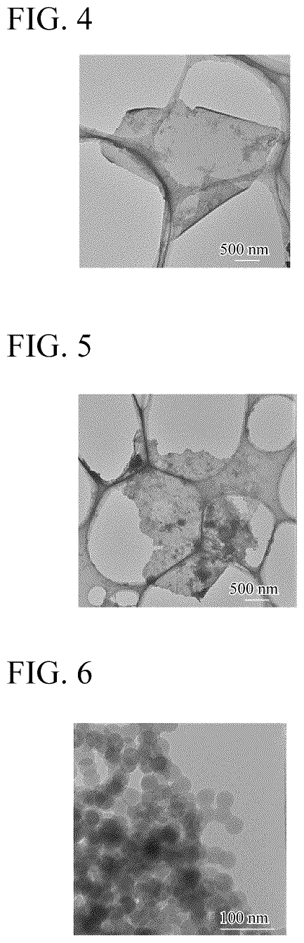

The TEM results are shown in FIGS. 4 to 6. As the TEM results, it was confirmed that nanosheet-like particles were produced.

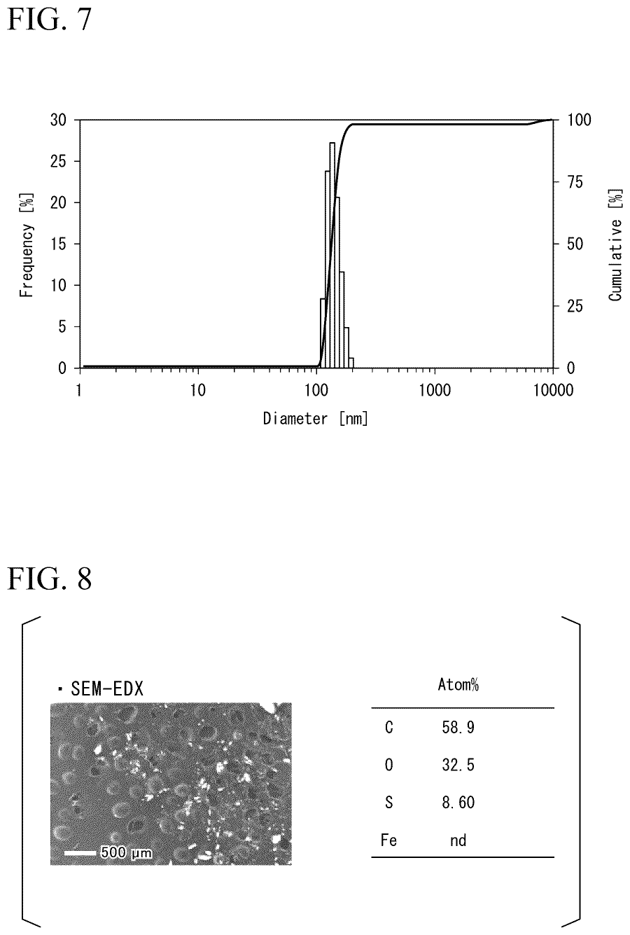

The DLS results are shown in FIG. 7.

TEM and DLS results confirmed sheet-like nanoparticles, which were composed of small connected nanoplatelets, with a small amount of aggregates present.

The electrical conductivity was measured and found to be approximately 1 S/cm.

SEM-EDX results are shown in FIG. 8. The removal of impurities (Fe) was confirmed.

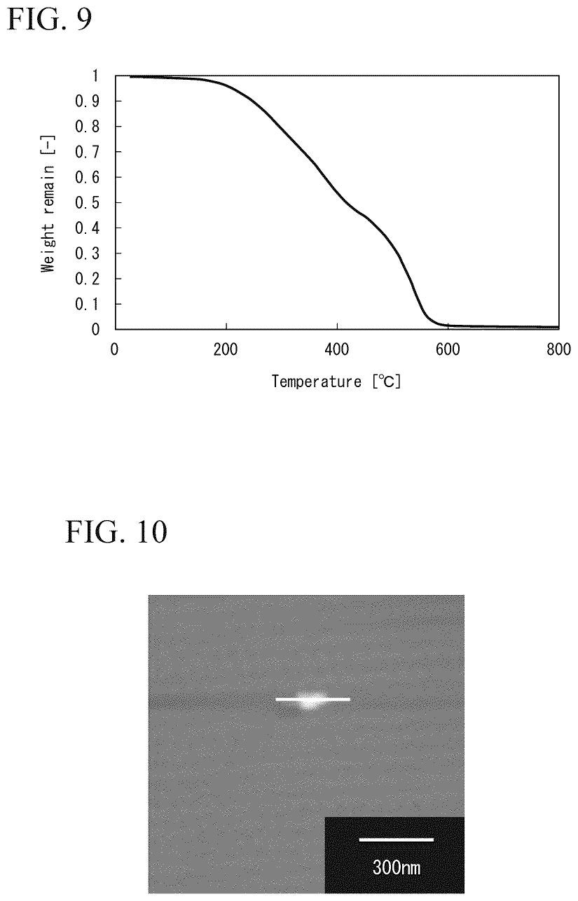

TG results are shown in FIG. 9. The removal of iron was confirmed.

### Examples A-2 to A-3

Nanosheet-like particles of PEDOT were obtained using the same method as in Example A-1, except that the added amount of 1-propanol used as a surfactant co-agent was modified as shown in Table 1.

TABLE 1

| (30 °C) | Example A-1 | Example A-2 | Example A-3 |
|---|---|---|---|
| Amount of 1- | 6.60 | 2.75 | 5.35 |
| Propanol | | | |
| (% by mass) | | | |
| Stability | A | B | B |

The evaluation criteria for “stability” in Table 1 are as follows.
A: Particularly favorable condition
B: Favorable condition

### Examples B-1 to B-2

Nanosheet-like particles of PEDOT were obtained in the same manner as in Example A-1, except that an alcohol shown in Table 2 was used as the surfactant co-agent.

TABLE 2

| | Example | Example | Example |
|---|---|---|---|
| (32 °C) | A-1 | B-1 | B-2 |
| Surfactant co-agent | 1-Propanol | 1-Butanol | 2-Propanol |
| Lamellar layer formation | A | A | A |

The evaluation criteria for “lamella layer formation” in Table 2 are as follows.
A: Particularly favorable condition

### Examples C-1 to C-5, Comparative Examples C-1 to C-6

3.4×10⁻⁴ g of PEDOT nanosheet-like particles obtained in Example A-1 were dispersed in a solvent (1 ml) shown in Table 3 and Table 4 (Comparative Example) to obtain a dispersion liquid. Dispersion of the nanosheet-like particles in the solvent was confirmed.

TABLE 3

| | Exam- | Exam- | Exam- | Exam- | Exam- |
|---|---|---|---|---|---|
| | ple | ple | ple | ple | ple |
| | C-1 | C-2 | C-3 | C-4 | C-5 |
| Sample | PEDOT | PEDOT | PEDOT | PEDOT | PEDOT |
| | Nano Ss | Nano Ss | Nano Ss | Nano Ss | Nano Ss |
| PSS Addition | No | No | No | No | No |
| (Yes or No) | | | | | |
| Dispersion | Hexane | Diethyl | Ethanol | Methanol | Water |
| Solvent | | Ether | | | |
| Stability | A | A | A | A | A |
| Dispersity | A | A | A | A | A |
| Electrical | A | A | A | A | A |
| Conductivity | | | | | |

TABLE 4

| | Comparative | Comparative | Comparative | Comparative | Comparative | Comparative |
|---|---|---|---|---|---|---|
| | Example | Example | Example | Example | Example | Example |
| | C-1 | C-2 | C-3 | C-4 | C-5 | C-6 |
| Sample | PEDOT | PEDOT | PEDOT | PEDOT | PEDOT | PEDOT |
| | Bulk | Non | Bulk | Non Nano | Bulk | Non Nano |
| | | Nano-Ss | | Ss | | Ss |
| PSS | Yes | Yes | No | No | No | No |
| Addition | | | | | | |
| (Yes or | | | | | | |
| No) | | | | | | |
| Dispersion | Water | Water | Water | Water | Ethanol | Ethanol |
| Solvent | | | | | | |
| Stability | B | B | D | B | D | B |
| Dispersity | B | B | D | D | D | D |
| Electrical | C | C | — | — | — | — |
| Conductivity | | | | | | |

The evaluation criteria for “dispersity” in Tables 3 and 4 are as follows.
A: Particularly favorable condition
B: Favorable condition
C: Favorable condition in some areas
D: Unfavorable condition

The evaluation criteria for “stability” in Tables 3 and 4 are as follows.
A: Particularly favorable condition
B: Favorable condition
C: Favorable condition in some areas
D: Unfavorable condition

The evaluation criteria for “electrical conductivity” in Tables 3 and 4 are as follows.
A: Particularly favorable condition
B: Favorable condition
C: Deteriorated from a desirable state

### (Discussion)

From the above results, it was found that the obtained PEDOT nanosheet-like particles could be dispersed in a solvent without PSS), and that the nanosheet-like particles were dispersed in both polar and nonpolar solvents.

### Example D-1

### (Production of Nanosheet-Like Particles of Polythiophene)

### <First Step>

### <Reagents and Reaction Conditions>

Thiophene (FUJIFILM Wako Pure Chemical Industries, Ltd., 0.12% by mass) 0.0356
Deionized water (88.8% by weight) 27.0 g
Hexane (FUJIFILM Wako Pure Chemical Industries, Ltd., 0.042% by mass) 0.0127 g 1-propanol (manufactured by Fujifilm Wako Pure Chemical Industries, Ltd., 6.74% by mass) 2.05 g
Polyethylene glycol dodecyl ether (Brij L4, Sigma-Aldrich, 4.31% by weight) 1.31 g
Reaction temperature: 30 °C.
Stirring speed: 300 rpm

0.0356 g of thiophene, 1.31 g of Brij (registered trademark) L4, 2.05 g of 1-propanol, 0.0127 g of hexane, and 27.0 g of water were added to a 50 ml screw tube. The mixture was then stirred at 30 °C and 300 rpm. After confirming the texture derived from the hyper-swollen lamellar phase with a polarizing plate, a mixed liquid having a hyper-swollen lamellar phase was obtained.

### <Second Step>

### <Reagents and Reaction Conditions>

Deionized water (3 ml)
FeCl₃·6H₂O (manufactured by Fujifilm Wako Pure Chemical Industries, Ltd.) 0.0010 g
Reaction temperature: 30 °C.
Reaction time: 24 hours

It was confirmed that the reaction occurred while maintaining the bilayer membrane.

3 ml of an aqueous solution of iron chloride was prepared using 0.0039 g of iron (III) chloride. The mixed solution obtained in the first step was heated to 30 °C, and 3 ml of the aqueous solution of iron (III) chloride was added dropwise to the mixed solution at 30 °C using a pipette.

### <Third Step>

The solvent, water, polymerization catalyst, surfactant co-agent, and amphipathic substance added in the first and second steps were removed by centrifugation. Ethanol and water were used as the solvents for washing. The added hexane, water, surfactant co-agent, and amphipathic substance were removed with ethanol, and the polymerization catalyst was removed with water. After washing, the product may be stored as a dispersion in ethanol or the like without drying. For drying, the product was left in an oven set at 90 °C to evaporate the solvent.

### <Evaluation Results>

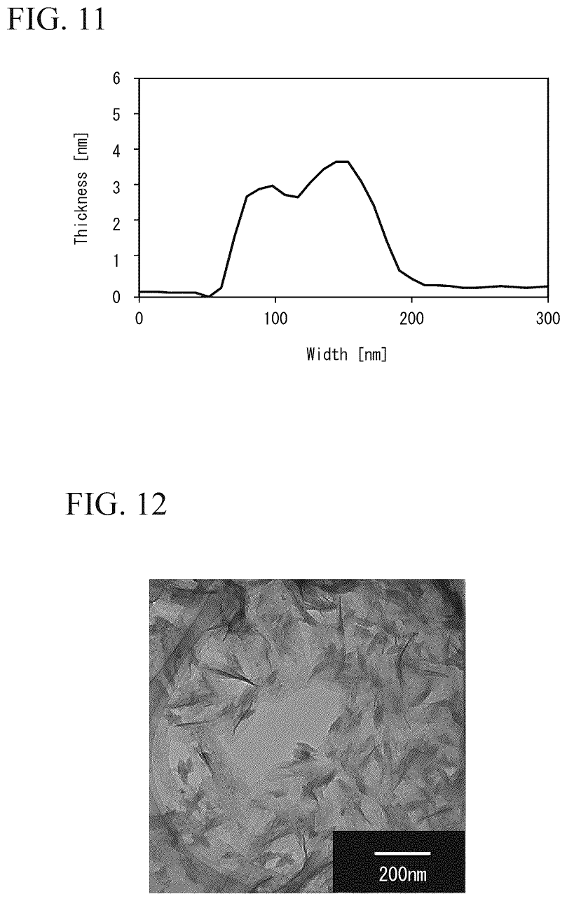

AFM results are shown in FIGS. 10 and 11.

The AFM measurement results showed that the thickness was 3.5 nm, the maximum planar width was 150 nm, and the aspect ratio (maximum width in the particle/thickness) was approximately 40.

The results of the TEM measurement are shown in FIG. 12. As a result of the TEM measurement, it was confirmed that nanosheet-like particles were produced.

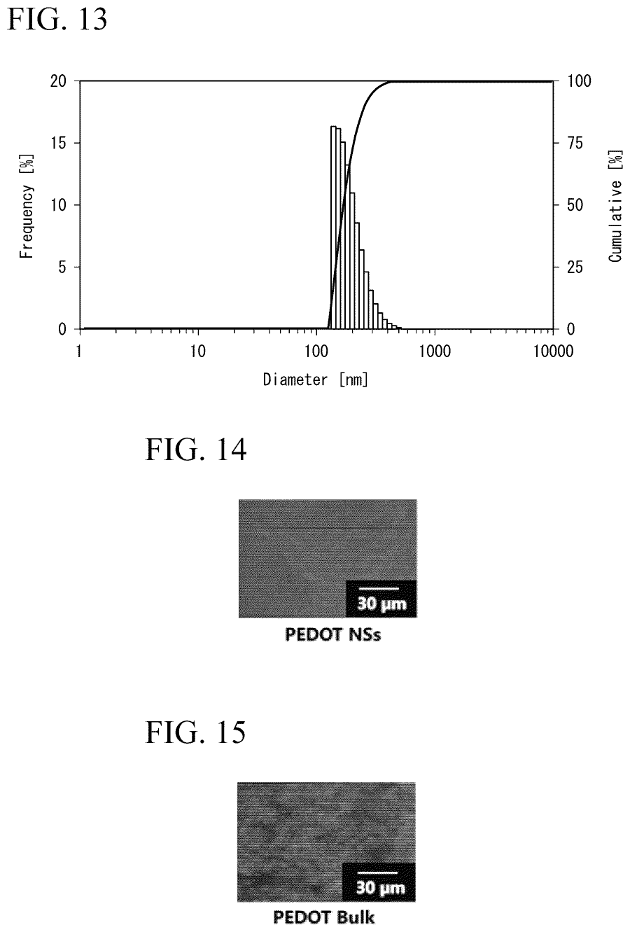

DLS results are shown in FIG. 13.

TEM and DLS results confirmed sheet-like nanoparticles, which were composed of small connected nanoplatelets, with a small amount of aggregates present.

### Example E-1

### (Measurement of Electrical Conductivity of PEDOT Nanosheet-Like Particles)

The nanosheet-like particles of PEDOT were obtained in the same manner as in Example A1. The electrical conductivity of the nanosheet-like particles of PEDOT was measured by the measurement method described in the above [Conductivity Measurement]. The results are shown in Table 5.

### Comparative Example E-1

### (Measurement of Electrical Conductivity of PEDOT Bulk Particles)

The electrical conductivity of the PEDOT bulk particles prepared in the same manner as in Example A-1, except that a solvent system not containing polyethylene glycol dodecyl ether was used, was measured in the same manner as in Example E-1. The results are shown in Table 5.

TABLE 5

| | | | Conductivity |
|---|---|---|---|
| | Sample | Shape | (S/cm) |
| Example E-1 | PEDOT Nanosheet-Like | Nanosheet | 3.35 |
| | Particles | | |
| Comparative | PEDOT Bulk Particles | Particles | 2.85 |
| Example E-1 | | | |

### <Discussion of Evaluation Results>

It was confirmed that the PEDOT nanosheet-like particles exhibited superior electrical conductivity compared to the PEDOT bulk particles.

### Example E-2

The coating property was evaluated by the evaluation method described in [Evaluation of Coating Property] above using the same PEDOT nanosheet-like particles as in Example E-1. It was confirmed by visual observation that the coating property was excellent in dispersion and uniformity.

A photograph of the evaluation sample taken with a research system BX-51 microscope (Olympus Corporation) is shown in FIG. 14.

### Comparative Example E-2

Using the same PEDOT bulk particles as in Comparative Example E-1, the coating property was evaluated in the same manner as in Example E-2. Visual observation confirmed that the dispersion and uniformity were poorer than those in Example E-2.

A photograph of the evaluation sample taken with a research system BX-51 microscope (Olympus Corporation) is shown in FIG. 15.

### <Discussion of Evaluation Results>

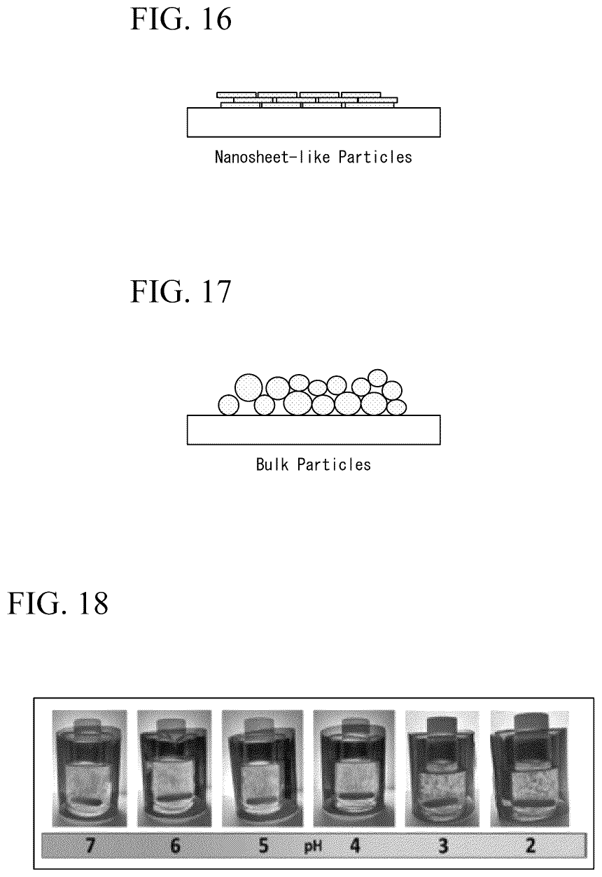

FIGS. 16 and 17 are schematic diagrams of the samples obtained in Example E-2 and Comparative Example E-2, respectively.

From the results of Example E-2 and Comparative Example E-2, it was confirmed that the PEDOT nanosheet-like particles exhibited superior dispersion and uniformity compared to the PEDOT bulk particles.

Specifically, as can be seen from the micrographs of FIGS. 14 and 15, the PEDOT nanosheet-like particles could be applied more uniformly to the comb-like electrode than the PEDOT bulk particles. This is probably because, in the case of the PEDOT bulk particles, the particle size is not uniform, and there are many voids between the particles when applied, whereas, in the case of the PEDOT nanosheet-like particles, the thickness of the particles (i.e., the sheets) is approximately uniform, so the particles tend to adhere to each other, and as a result, there are fewer voids between the particles (sheets) when applied.

The results of the conductivity measurements of Example E-1 and Comparative Example E-1 indicate that the reduction in the voids between the particles leads to a reduction in contact resistance, and as a result, the conductivity of the PEDOT nanosheet-like particles increases, and therefore the conductivity is improved.

### Example E-3

### “Effect of Manufacturing Conditions (pH) on Formation of PEDOT Nanosheet-Like Particles”

EDOT (0.13% by mass), hydrogen peroxide (0.65% by mass), Brij L4 (4.57% by mass), 1-propanol (6.52% by mass), and phosphate buffer solutions (88.1% by mass) previously prepared at various pH values (pH 2, 3, 4, 5, 6, 7) were added to a screw tube and mixed. The resulting mixtures were stirred at room temperature (25 °C). During stirring, the presence or absence of the formation of the hyper-swelled lamellar phase was observed while checking the birefringence derived from the hyper-swelled lamellar phase. The results are shown in FIG. 18. The evaluation results from the photographs in FIG. 18 are shown in Table 6 below.

TABLE 6

| | pH value | | | | | |
|---|---|---|---|---|---|---|
| | 7 | 6 | 5 | 4 | 3 | 2 |
| Evaluation of the formation | B | B | B | B | B | B |
| of a hyper-swollen | | | | | | |
| lamellar phase | | | | | | |

The evaluation criteria for “formation of hyper-swollen lamellar phase” in FIG. 18 were as follows.
B: Favorable condition
C: Favorable condition in some areas
D: Unfavorable condition

### <Discussion>

According to the results of FIG. 18, the formations of the hyper-swollen lamellar phase were observed at any pH value from 2 to 7, which confirmed that this was a favorable state (i.e., a state in which thin nanosheets can be stably produced) and that the pH values did not affect the formation of the hyper-swollen lamellar phase. In particular, it was found that any pH values between pH 2 and pH 4 indicated a particularly favorable state (i.e., a state in which very stable nanosheets can be produced at the largest size) and did not have a significant effect on the yield of PEDOT nanosheet-like particles.

### Example E-4

### “Effect of Manufacturing Conditions (pH) on Yield of PEDOT Nanosheet-Like Particles”

EDOT (0.13% by mass), hydrogen peroxide (0.65% by mass), Brij L4 (4.57% by mass), 1-propanol (6.52% by mass), and phosphate buffer solutions (88.1% by mass) previously prepared at various pH values (pH 2, 3, 4, 5) were added to a screw tube and mixed. Each of the resulting mixtures was stirred at room temperature (25 °C.). During stirring, the presence or absence of formation of a hyper-swelled lamellar phase was observed while checking the birefringence derived from the hyper-swelled lamellar phase.

After the above operation, an aqueous solution of iron chloride was added to the resulting mixture. The resulting mixture was further stirred for 24 hours. After the stirring was completed, the collected mixture was centrifuged at 11,000 rpm, and the precipitate was collected. The collected precipitate was washed three times with ethanol, and then the mass of the dried product obtained by drying was measured, and the yield of the obtained PEDOT nanosheet-like particles was calculated. The results are shown in FIG. 19.

### <Discussion>

From the results of FIG. 19, it was confirmed that a pH value between pH 2 and 4 did not have a significant effect on the yield of PEDOT nanosheet-like particles.

### Example E-5

### “Effect of Manufacturing Conditions (Addition of SDS) on Yield of PEDOT Nanosheet-Like Particles”

EDOT (0.13% by mass), hydrogen peroxide (0.65% by mass), Brij L4 (4.57% by mass), 1-propanol (6.52% by mass), and water (88.1% by mass) were added to a screw tube and mixed. The resulting mixture was stirred at room temperature (25 °C) to form a hyper-swollen lamellar phase.

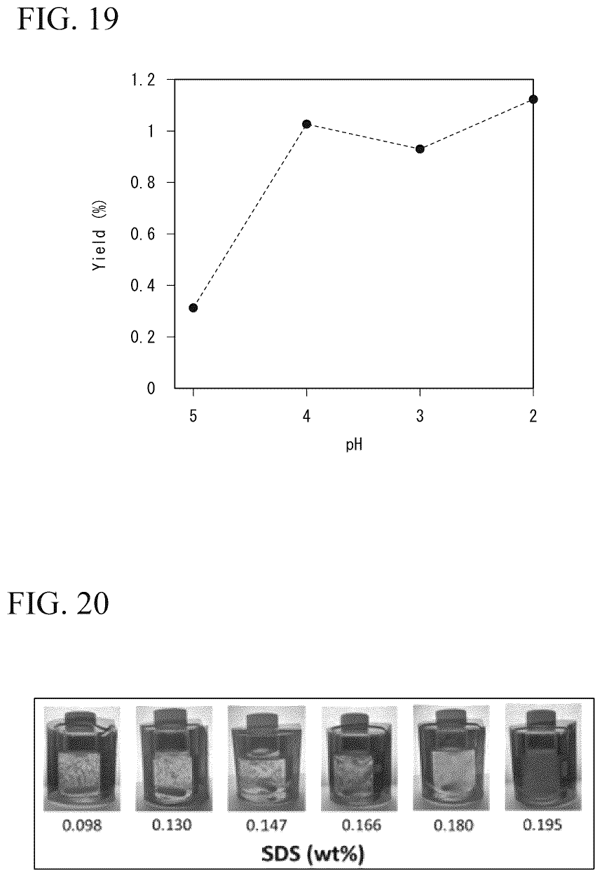

Next, sodium dodecyl sulfate (SDS) was added to the mixture containing the formed hyper-swollen lamellar phase so that various concentrations of sodium dodecyl sulfate (SDS) were added (0.098% by mass, 0.130% by mass, 0.147% by mass, 0.166% by mass, 0.180% by mass, 0.195% by mass), and mixed. Each of the resulting mixtures was stirred at room temperature (25 °C.). During stirring, the stability of the hyper-swollen lamellar phase was observed by monitoring the birefringence derived from the hyper-swollen lamellar phase. The results are shown in FIG. 20. The evaluation results from the photographs in FIG. 20 are shown in Table 7 below.

TABLE 7

| | Added concentration of SDS (% by mass) | | | | | |
|---|---|---|---|---|---|---|
| | 0.098 | 0.130 | 0.147 | 0.166 | 0.180 | 0.195 |
| Evaluation of the formation | B | B | B | B | B | B |
| of hyper-swollen | | | | | | |
| lamellar phase | | | | | | |

The evaluation criteria for “stability of the hyper-swollen lamellar phase” in FIG. 20 were as follows.
B: Favorable condition
C: Favorable condition in some areas
D: Unfavorable condition

### <Discussion>

From the results of FIG. 20, it was found that when the SDS concentration was between 0.098% by mass and 0.147% by mass, a favorable state was achieved (i.e., a state in which thin nanosheets could be stably produced). Furthermore, all of the concentrations exhibited a particularly favorable state (i.e., a state in which the nanosheets were very stable and the largest possible size could be produced), confirming that the hyper-swollen lamellar phase remained highly stable.

1. A nanosheet-like particle, which is a nanosheet-like particle of a polythiophene-based compound,
wherein a thickness of the nanosheet-like particle is 0.5 nm or more and 10 nm or less, and
an aspect ratio of the nanosheet-like particle is 100 or more.

2. The nanosheet-like particle according to claim 1,
wherein the polythiophene-based compound is poly(3,4-ethylenedioxythiophene).

3. The nanosheet-like particle according to claim 1,
wherein a thickness of the nanosheet-like particle is 1 nm or more and 5 nm or less, and
a width of the nanosheet-like particle in a planar direction is 200 nm or more and 100 μm or less.

4. A method for producing a nanosheet-like particle of a polythiophene-based compound, comprising:
a first step of forming a layer of a thiophene-based compound between two monomolecular phases constituting one bilayer membrane
by forming a hyper-swollen lamellar phase of the bilayer membrane which is formed by forming a bilayer membrane in a solvent, and adding a thiophene-based compound to the solvent; and
a second step of forming the nanosheet-like particle of the polythiophene-based compound by oxidatively polymerizing the thiophene-based compound which formed a layer in the first step using a polymerization catalyst.

5. The method for producing the nanosheet-like particle of the polythiophene-based compound according to claim 4,
wherein in the first step, the hyper-swollen lamellar phase of the bilayer membrane is formed under a temperature condition of 20 °C or higher and 40 °C or lower.

6. The method for producing the nanosheet-like particle of the polythiophene-based compound according to claim 4,
wherein the thiophene-based compound is 3,4-ethylenedioxythiophene, and
the polythiophene-based compound is poly(3,4-ethylenedioxythiophene).

7. The method for producing the nanosheet-like particle of the polythiophene-based compound according to claim 4,
wherein the polymerization catalyst is iron (III) chloride.

8. The method for producing the nanosheet-like particle of the polythiophene-based compound according to claim 4,
wherein the solvent is a solvent consisting of only water, or a mixed solvent comprising a hydrocarbon-based solvent and water, and
a mass ratio of the hydrocarbon-based solvent to the water in the solvent is hydrocarbon-based solvent:water=0:100 to 15:85.

9. The method for producing the nanosheet-like particle of the polythiophene-based compound according to claim 4,
wherein the solvent is a mixed solvent comprising a hydrocarbon solvent and water, and
a mass ratio of the hydrocarbon solvent to water in the solvent is hydrocarbon solvent:water=0.01:99.99 to 15:85.

10. The method for producing the nanosheet-like particle of the polythiophene-based compound according to claim 9,
wherein the hydrocarbon solvent is hexane.

11. The method for producing the nanosheet-like particle of the polythiophene-based compound according to claim 4,
wherein an amphiphilic substance constituting the bilayer membrane is polyethylene glycol monoalkyl ether.

12. The method for producing the nanosheet-like particle of the polythiophene-based compound according to claim 11,
wherein the polyethylene glycol monoalkyl ether is tetraethylene glycol monomethyl ether.

13. The method for producing the nanosheet-like particle of the polythiophene-based compound according to claim 11,
wherein the polyethylene glycol monoalkyl ether is tetraethylene glycol monododecyl ether having a number average molecular weight of 362 or less.

14. The method for producing the nanosheet-like particle of the polythiophene-based compound according to claim 4,
wherein the solvent comprises a monohydric alcohol.

15. The method for producing the nanosheet-like particle of the polythiophene-based compound according to claim 14,
wherein the monohydric alcohol is at least one selected from the group consisting of 1-propanol, 2-propanol, and 1-butanol.

16. The method for producing the nanosheet-like particle of the polythiophene-based compound according to claim 14,
wherein the monohydric alcohol is 1-propanol.

17. The method for producing the nanosheet-like particle of the polythiophene-based compound according to claim 15,
wherein a content of the monohydric alcohol in the solvent is 0.1% by mass or more and 10% by mass or less.

18. The method for producing the nanosheet-like particle of the polythiophene-based compound according to claim 4,
wherein a thickness of the nanosheet-like particle is 0.5 nm or more and 10 nm or less,
a width of the nanosheet-like particle in a planar direction is 200 nm or more and 100 μm or less, and
an aspect ratio of the nanosheet-like particle (maximum width in the particle/thickness) is 100 or more.

19. A dispersion composition comprising the nanosheet-like particle according to claim 1.

20. The dispersion composition according to claim 19, which further comprises a monohydric alcohol and which is substantially free of water.
